(19) United States
(12) Patent Application Publication
(10) Pub. No.: US 2008/0091695 A1
(43) Pub. Date: Apr. 17, 2008

(54) Apparatus, method and computer program product for assigning element of structured-text

(76) Inventor: Daisuke Nagasawa, Bangalore (IN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/896,207

(22) Filed: Aug. 30, 2007

(30) Foreign Application Priority Data
Sep. 28, 2006 (JP) 2006-265025

(51) Int. Cl. G06F 17/30

(52) U.S. Cl. 707/100; 707/E17.002

(57) ABSTRACT

An apparatus for assigning an element in a structured-text includes a storage unit that stores element-assigning correspondence information in which a structure path expression and assignment information are associated with each other, the structure path expression specifying an element relative to a structured-text that holds elements using a hierarchical logical structure, and the assignment information defining assignment/deassignment of the element specified by the structure path expression; an acquiring unit that acquires an element matching the structure path expression from the structured-text, based on the structure path expression; an assignment acquiring unit that acquires the assignment information associated with the structure path expression used for acquiring the element from the element-assigning correspondence information; an element determining unit that determines whether to assign or deassign the element based on the acquired assignment information; and an assigning unit that assigns or deassigns the element determined by the element determining unit.

### CROSS-REFERENCE TO RELATED APPLICATIONS

This application is based upon and claims the benefit of priority from the prior Japanese Patent Application No. 2006-265025, filed on Sep. 28, 2006; the entire contents of which are incorporated herein by reference.

### BACKGROUND OF THE INVENTION

1. Field of the Invention

The present invention relates to an apparatus, a method and a computer program product for assigning an element of a structured-text, which assign an element matching a condition from the structured-text in which elements are stored, using a hierarchical logical structure.

2. Description of the Related Art

A structured-text involves elements structured by a predetermined sign and holds a logical relation of respective elements (document logical structure) due to the structure. As an example of metalanguage for describing the structured-text, there is an extensible markup language (XML), which is provided by the World Wide Web Consortium (W3C) and is rapidly becoming popular in recent years.

To manage the structured-texts, a structured-text database is used. The structured-text database manages information indicating a logical relation of elements held by the structured-text. When a user sets the structure of the structured-text as a search condition, a search with high accuracy is realized by using the information at the time of a search.

To make a search at a high speed when the structure is set as the search condition, there is a technique that uses an index at the time of a search, which is generated previously in a structured-text management database relative to each hierarchy or element of the structured-text.

For example, in JP-A 2005-190163 (KOKAI), a structured data search apparatus includes an index data storage unit. The index data storage unit stores text data and an object ID indicating each element in the structured-text including the text data in association with each other.

The structured-text can hold a complicated structure, as compared to a normal document. Further, to generate index information, the index information is generated normally relative to only elements or the like considered to be used at the time of a search.

That is, to set the index, the element set as the index needs to be assigned explicitly in a unit of element by using the structure. When the element is explicitly assigned in a unit of element by using the structure, generally, a schema language or an addressing language is used.

However, the structured-texts have often a different structure for each document. For example, the XML can freely define the logical structure and the name of components of the document, and therefore the structure can be different largely for each document frequently.

To assign the element for which the index information is to be generated, relative to the structured-text, using the conventional schema language, the user needs to know the structure for each structured-text beforehand, to describe the element for which an index is to be generated. Accordingly, there is a problem that the user bears a great burden.

### SUMMARY OF THE INVENTION

According to one aspect of the present invention, an apparatus for assigning an element in a structured-text includes a storage unit that stores element-assigning correspondence information in which a structure path expression and assignment information are associated with each other, the structure path expression specifying an element relative to a structured-text that holds elements using a hierarchical logical structure, and the assignment information defining assignment/deassignment of the element specified by the structure path expression; an acquiring unit that acquires an element matching the structure path expression from the structured-text, based on the structure path expression in the element-assigning correspondence information; an assignment acquiring unit that acquires the assignment information associated with the structure path expression used for acquiring the element from the element-assigning correspondence information; an element determining unit that determines whether to assign or deassign the element based on the acquired assignment information; and an assigning unit that assigns or deassigns the element determined by the element determining unit.

According to another aspect of the present invention, a method for assigning an element of a structured-text includes acquiring element-assigning correspondence information in which a structure path expression and assignment information are associated with each other, the structure path expression specifying an element relative to a structured-text that holds elements using a hierarchical logical structure, and the assignment information defining assignment/deassignment of the element specified by the structure path expression; acquiring an element matching the structure path expression from the structured-text, based on the structure path expression in the acquired element-assigning correspondence information; acquiring the assignment information associated with the structure path expression used for acquiring the element from the element-assigning correspondence information; determining whether to assign or deassign the element based on the acquired assignment information; and performing assigning or deassigning the element determined by the element determining unit.

A computer program product according to still another aspect of the present invention causes a computer to perform the method according to the present invention.

### BRIEF DESCRIPTION OF THE DRAWINGS

FIG. 1 is a block diagram of a configuration of a structured-text management apparatus according to a first embodiment of the present invention;

FIG. 2 is a schematic diagram illustrating structured-text data;

FIG. 3 is a schematic diagram for explaining a concept of a tree structure in which the structured-text data shown in FIG. 2 is broken down;

FIG. 4 is a schematic diagram illustrating a data structure of filter data stored in a filter storage unit according to the first embodiment;

FIG. 5 is a flowchart of a process procedure until an index relative to the structured-text data input to the structured-text management apparatus;

FIG. 6 is a diagram illustrating a concept of a subtree in an intermediate result after a rule of rule number ‘1’ of the filter data shown in FIG. 4 is applied to the structured-text data shown in FIG. 3;

FIG. 7 is a diagram illustrating the concept of the subtree in the intermediate result after rules up to rule number “3” of the filter data are applied;

FIG. 8 is a diagram illustrating the concept of the subtree in the intermediate result after rules up to rule number “4” of the filter data are applied;

FIG. 9 is a diagram illustrating the concept of the subtree after all rules of the filter data are applied;

FIG. 10 is a diagram illustrating a data structure of a conventional filter data;

FIG. 11 is a schematic diagram illustrating first structured-text data in an XHTML format to be processed by a structured-text management apparatus according to a second embodiment of the present invention;

FIG. 12 is a schematic diagram for explaining a concept of the tree structure in which the first structured-text data is broken down;

FIG. 13 is a schematic diagram illustrating second structured-text data in the XHTML format to be processed by the structured-text management apparatus according to the second embodiment;

FIG. 14 is a schematic diagram for explaining the concept of the tree structure in which the second structured-text data is broken down;

FIG. 15 is a schematic diagram illustrating the data structure of the filter data stored in the filter storage unit according to the second embodiment;

FIG. 16 is a diagram illustrating the concept of the subtree after all rules of the filter data shown in FIG. 15 are applied to the tree structure of the first structured-text data shown in FIG. 12;

FIG. 17 is a diagram illustrating the concept of the subtree after all rules of the filter data shown in FIG. 15 are applied to the tree structure of the second structured-text data shown in FIG. 14; and

FIG. 18 is a diagram illustrating a hardware configuration of the structured-text management apparatus.

### DETAILED DESCRIPTION OF THE INVENTION

Exemplary embodiments of an apparatus, a method and a computer program product for assigning an element of a structured-text according to the present invention will be explained below in detail with reference to the accompanying drawings. In the embodiments below, an example in which an apparatus for assigning elements of a structured-text is applied to a structured-text management apparatus is explained. The apparatus for assigning elements of a structured-text can be applied to various apparatuses other than the structured-text management apparatus.

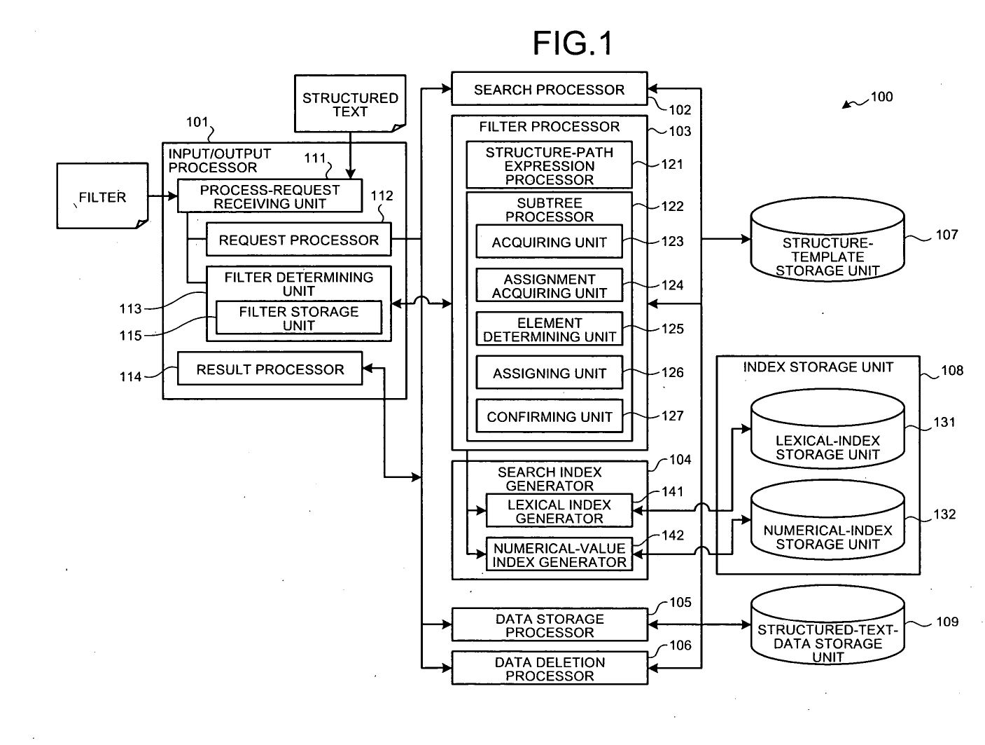

As shown in FIG. 1, the structured-text management apparatus 100 includes an input/output processor 101, a search processor 102, a filter processor 103, a search index generator 104, a data storage processor 105, a data deletion processor 106, a structure-template storage unit 107, an index storage unit 108, and a structured-text-data storage unit 109.

The structured-text data can be in any format; however, there are text data described in, for example, SGML, XML, and extensible hypertext markup language (XHTML), which is a subset of XML. In the first embodiment, an example in which the structured-text management apparatus 100 performs processing to the structured-text described in the XML format is explained.

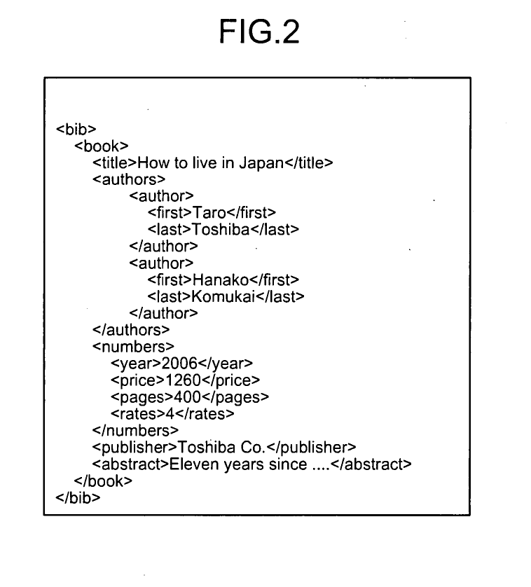

The structured-text data shown in FIG. 2 is described in the XML format. The structured-text data described in the XML format forms an element by paired tags. The paired tags are assumed to be a start tag and an end tag. The element not including the tag therein is assumed to be a data element.

The structured-text data has a nesting structure by these elements. In FIG. 2, element “bib” includes element “book”, and element “book” includes “title”, “author”, and the like. Further, a data element is included immediately below element “title”. Entity data of the data element is “How to live in Japan”.

In the XML format, the same elements can be arranged in the element so that element “author” includes two element “author” in the example shown in FIG. 2. In the XML format, an element not including the element immediately below can be described. In the example shown in FIG. 2, element “rates” corresponds thereto.

Returning to FIG. 1, the input/output processor 101 includes a process-request receiving unit 111, a request processor 112, a filter determining unit 113, and a result processor 114, and processes data to be input and output relative to the structured-text management apparatus 100.

The process-request receiving unit 111 receives a request or information input to the structured-text management apparatus 100 from an external device. For example, the process-request receiving unit 111 receives a search request or an input of the structured-text data to be managed or the filter data from a user.

A rule for assigning an element held in the structured-text data is described in the filter data, and details of the rule are described later.

The request processor 112 breaks down the input structured-text data into the tree structure and the entity data.

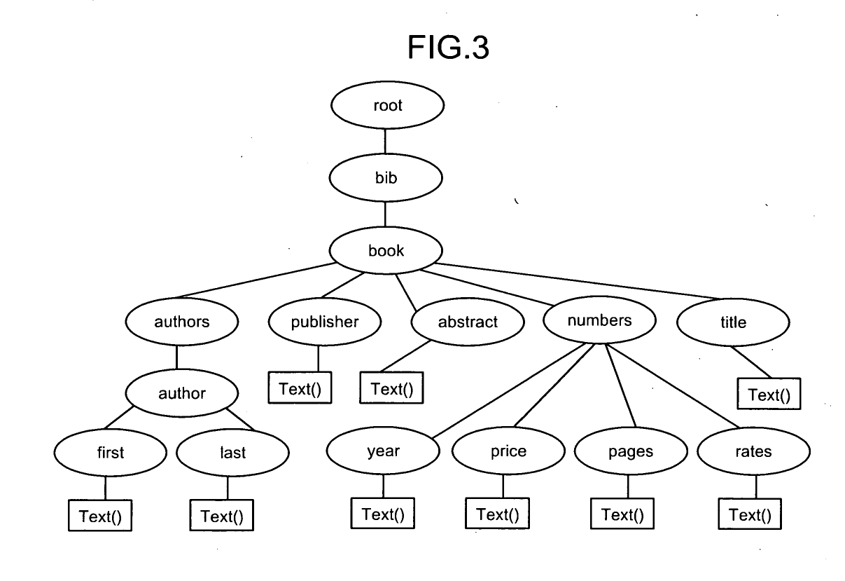

Circles shown in FIG. 3 express elements, squares express data elements, and a link connecting between the element and the data element is arc.

The filter determining unit 113 includes a filter storage unit 115. When the filter data is input, the filter determining unit 113 stores the filter data in the filter storage unit 115 and outputs the rule for assigning the element of the structured-text data from the filter data to a subtree processor 122. The filter storage unit 115 stores the filter data for filtering the structured-text data.

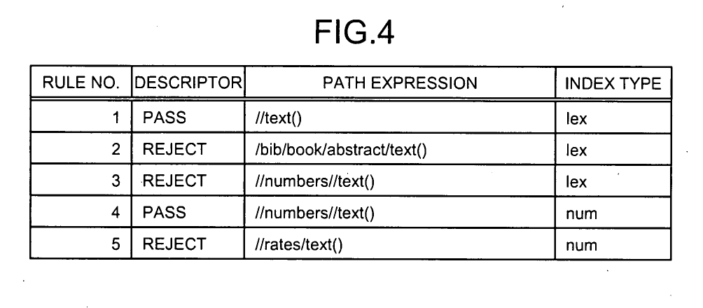

As shown in FIG. 4, a rule for assigning or deassigning the element in the structured-text data is stored in respective lines in the filter data stored as a descriptor in the filter storage unit 115. In the respective rules, rule number, descriptor, structure path expression, and index type are associated with each other, as shown in FIG. 4. In the structured-text management apparatus 100 according to the first embodiment, the element in the structured-text data is assigned using these rules. A detailed process procedure will be described later. That is, the filter data corresponds to element-assigning correspondence information.

In the path expression shown in FIG. 4, reference sign “/” between the elements indicates an element immediately below the element, and reference sign “//” between the elements indicates all elements below the element. Thus, by using reference signs between the elements in different ways, assignment of the element becomes easy, thereby reducing the burden on the user.

It is assumed that the filter data shown in FIG. 4 is described when the user desires “to set a lexical index excluding the abstract tag and the numbers tag and therebelow and set a numerical value to all elements excluding rates tag below the numbers tag”.

The rule number holds a sequence for applying the rule. The descriptor holds whether the rule passes an element as the filter. When the descriptor is “PASS”, the element is assigned as a result of passing the element as the filter. When the descriptor is “REJECT”, the element is deassigned as a result of not passing the element as the filter. The index type indicates the type of the search index. When the index type is “lex”, an index is generated as a characteristic string, and when the index type is “num”, an index is generated as a numerical value.

Returning to FIG. 1, the result processor 114 outputs a result of the process performed by the structured-text management apparatus 100. For example, the result processor 114 outputs the search result performed by the search processor 102 in response to a request from the user to the user.

Upon reception of a search request from the user, the search processor 102 searches the structure-template storage unit 107 or the structured-text-data storage unit 109. When the index storage unit 108 holds the index to be searched, the search processor 102 performs a search using the index.

The filter processor 103 includes a structure-path expression processor 121 and the subtree processor 122.

The structure-path expression processor 121 acquires the structured-text data stored in the structured-text-data storage unit 109 or a structure template stored in the structure-template storage unit and breaks down the structured-text data or the like into the tree structure and the entity data, to output the tree structure and the entity data to the subtree processor 122.

The subtree processor 122 includes an acquiring unit 123, an assignment acquiring unit 124, an element determining unit 125, and an assigning unit 126, to assign an element in the structured-text data from the tree structure and the entity data based on the rule described in the filter data.

The acquiring unit 123 acquires a subtree that matches the path expression from the tree structure of the input structured-text data based on the path expression described in the rule input from the filter determining unit 113.

When a subtree as the intermediate result for holing the assigned element is generated by the process performed last time, the acquiring unit 123 compares the subtree in the intermediate result with the acquired subtree. The acquiring unit 123 then acquires a first divided subtree formed of an element not included in the subtree in the intermediate result of the subtree acquired this time and a second subtree formed of an element included in the subtree in the intermediate result of the acquired subtree.

The assignment acquiring unit 124 acquires the descriptor associated with the path expression used for acquiring the subtree by the acquiring unit 123. The descriptor is input from the filter determining unit 113.

The element determining unit 125 determines whether the descriptor acquired by the assignment acquiring unit 124 is “PASS” or “REJECT”. When the descriptor is “PASS”, the element included in the acquired subtree becomes an assignment target, and when the descriptor is “REJECT”, the element included in the acquired subtree becomes a deassignment target.

The assigning unit 126 assigns or deassigns the element included in the determined subtree. In the first embodiment, when the determination result is “PASS”, the assigning unit 126 connects the subtree in the previous intermediate result to the first divided subtree. When the determination result is “REJECT”, the assigning unit 126 deletes the second divided subtree from the subtree in the previous intermediate result. The index type associated with the path expression used in the current process and the path information indicating the element are added to the respective elements of the subtree to be connected or deleted. The added path information is used as identification information for identifying the element.

A confirming unit 127 confirms whether there is a contradiction in the subtree after the connection or deletion, every time each rule in the filter data is applied.

Further, the confirming unit 127 confirms whether the finally acquired subtree after all the rules in the filter data have been applied is appropriate for outputting to the respective index processors. For example, the confirming unit 127 determines whether the subtree is “Valid”. The confirming unit 127 further confirms whether there is a contradiction in the index type added to the respective elements and the entity data. “Valid” means that the subtree satisfies a condition of a well-formed XML format and fitted for an individual document type definition (DTD).

The reason why the confirming unit 127 determines whether the subtree is “Valid” is that there can be a restriction according to the database system and the index type thereof, for example, “all the elements for setting a specific index must be followed from the route element”, “the element for setting a numerical index must not include data other than numerals”, or “an index cannot be set for an attribute value”.

The index is generated as long as the appropriate element is included in the subtree by performing the confirmation process by the confirming unit 127. Accordingly, reliability of the generated index is improved. The index is output to the search index generator 104 if there is no problem according to the confirmation.

The search index generator 104 includes a lexical index generator 141 and a numerical-value index generator 142. The search index generator 104 generates the index, thereby enabling a high-speed search of the element held in the structured-text data.

The lexical index generator 141 generates the index relative to the element added with index type “lex” by the filter processor 10, of the structured-text data, and stores the generated index in a lexical-index storage unit 131.

The numerical-value index generator 142 generates the index relative to the element added with index type “num” by the filter processor 10, of the structured-text data, and stores the generated index in a numerical-index storage unit 132.

The data storage processor 105 stores the input structured-text data in the structured-text-data storage unit 109, and when the subtree used by the user is extracted from the structured-text data, stores the subtree in the structure-template storage unit 107.

The data deletion processor 106 deletes the structured-text data stored in the structured-text-data storage unit 109 or the subtree data stored in the structure-template storage unit 107 in response to a request from the user.

The structure-template storage unit 107 stores structure template data. The structure template data is structure data obtained by extracting only the required subtree to be used by the user from the input structured-text data.

The index storage unit 108 includes the lexical-index storage unit 131 and the numerical-index storage unit 132, and stores the index generated relative to the structured-text data.

The lexical-index storage unit 131 generates a lexical index to the element added with index type “lex” of the elements included in the subtree input from the filter processor 103 and stores the lexical index in the lexical-index storage unit 131. The lexical-index storage unit 131 uses the path information added to the element to generate the lexical index.

The numerical-index storage unit 132 generates a numerical index to the element added with index type “num” of the elements included in the subtree input from the filter processor 103 and stores the numerical index in the numerical-index storage unit 132. The numerical-index storage unit 132 uses the path information added to the element to generate the numerical index.

The structured-text-data storage unit 109 stores the structured-text data. The storage method can be any method regardless of being well-known.

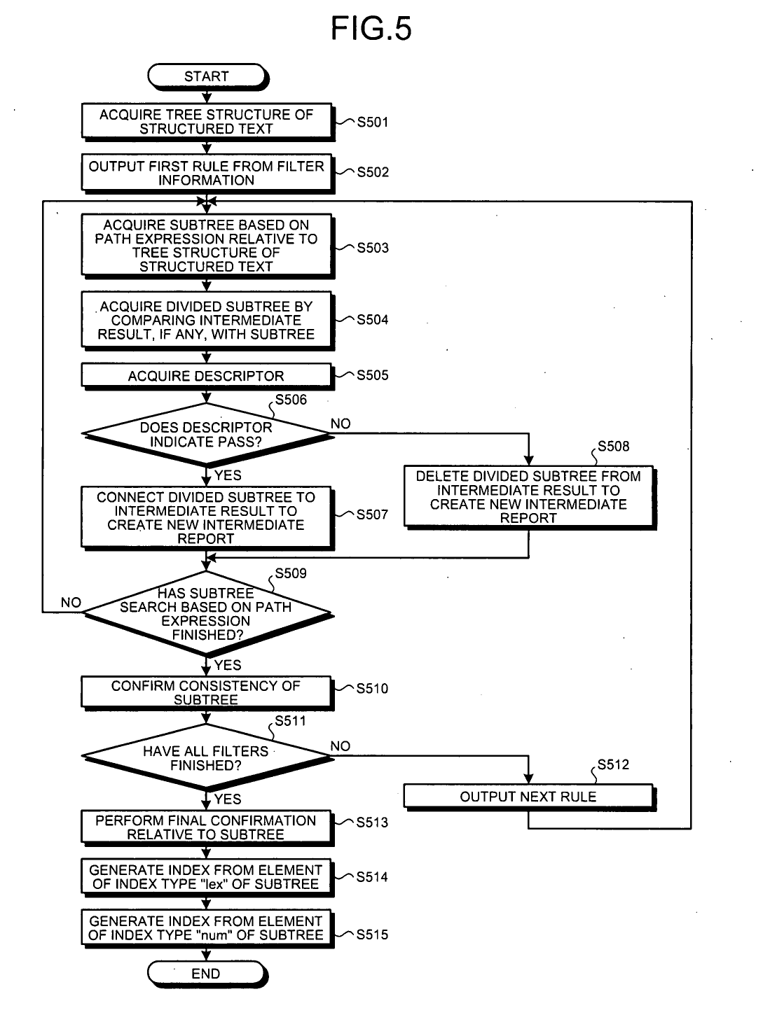

A process procedure until the index relative is generated relative to the structured-text data input to the structured-text management apparatus shown in FIG. 1 is explained next with reference to FIG. 5. It is assumed that the filter data for assigning the element for generating the index has already been stored in the filter storage unit 115.

The request processor 112 breaks down the input structured-text data to acquire the tree structure and the entity data of the structured-text data (step S501). The acquired tree structure and the entity data of the structured-text data are output to the filter processor 103.

The filter determining unit 113 outputs the first rule of the filter data stored in the filter storage unit 115 to the filter processor (step S502).

The acquiring unit 123 searches the tree structure of the structured-text data to acquire the subtree matching the condition of the path expression indicated in the input rule (step S503).

When there is the subtree in the intermediate result, the acquiring unit 123 compares the subtree with the acquired subtree to acquire the divided subtree (step S504). That is, the acquiring unit 123 acquires the first divided subtree formed of the element not included in the subtree in the intermediate result of the subtrees acquired this time and the second subtree formed of the element included in the subtree in the intermediate result of the acquired subtrees. When there is no subtree in the intermediate result, all the acquired subtrees become the first divided subtree and there is no second divided subtree.

The assignment acquiring unit 124 acquires the descriptor indicated in the input rule (step S505). The element determining unit 125 then determines whether the acquired descriptor is “PASS” (step S506).

When the element determining unit 125 determines that the acquired descriptor is “PASS” (YES at step S506), the assigning unit 126 connects the first divided subtree to the subtree in the intermediate result, thereby acquiring a subtree in the new intermediate result (step S507).

When the element determining unit 125 determines that the acquired descriptor is “REJECT” (NO at step S506), the assigning unit 126 deletes the second divided subtree from the subtrees in the intermediate result to acquire a subtree in the new intermediate result (step S508). When there is no subtree in the intermediate result, a particular process is not performed.

The acquiring unit 123 then determines whether all the tree structures of the text data are searched based on the input path expression (step S509). When having determined that not all the tree structures have searched yet (NO at step S509), the acquiring unit 123 searches the tree structure again (step S503).

When having determined that all the tree structures are searched (YES at step S509), the confirming unit 127 confirms consistency of the subtrees in the intermediate result (step S510). When the confirmation process is a success, a particular process is not performed. When the confirmation process is a failure, it is regarded as an abnormal state, and a process for notifying the user of this matter or the like is performed.

The filter determining unit 113 then determines whether all the rules included in the filter data have been output (step S511). When having determined that all the rules have not been output (NO at step S511), the filter determining unit 113 outputs the next rule to the filter processor 103 (step S512).

When the filter determining unit 113 determines that all the rules included in the filter data have been output (YES at step S511), the confirming unit 127 performs a final confirmation process relative to the subtree (step S513). The process when the confirmation process is a success or a failure is the same as at step S510.

The lexical index generator 141 generates the index using the element of index type “lex” of the acquired subtree and stores the generated index in the lexical-index storage unit 131 (step S514).

The numerical-value index generator 142 generates the index using the element having index type “num” of the acquired subtree and stores the generated index in the numerical-index storage unit 132 (step S515).

In the process procedure, the process for adding the index to the input structured-text data has been explained. However, when the index is to be generated, a case that an index is generated relative to the structured-text or the like already stored in the structured-text-data storage unit 109 can be also considered. In this case, the index can be generated by performing the same process.

The subtree in which an element is connected or deleted according to each rule of the filter data is explained next. The process performed for each rule has been shown in FIG. 5, and therefore explanations thereof will be omitted.

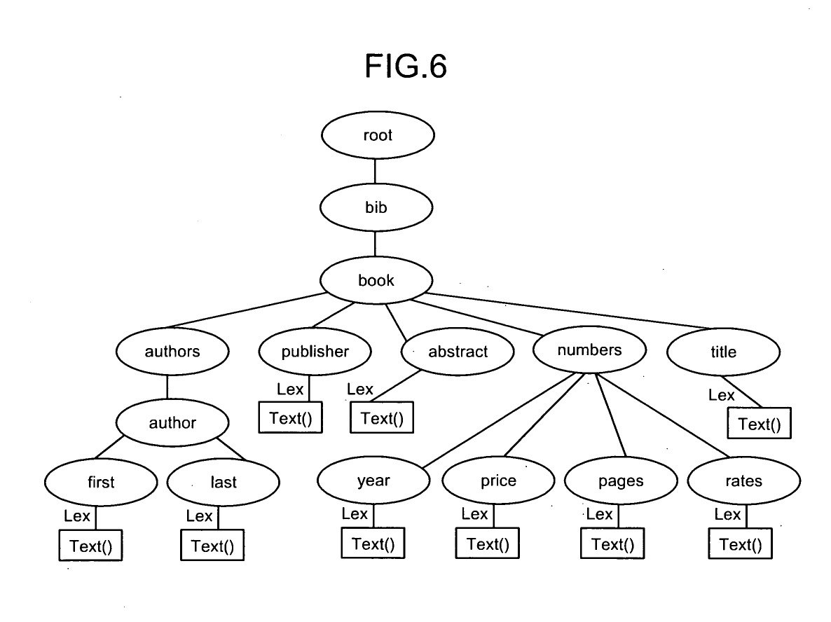

As shown in FIG. 6, a path expression (XPath expression) “//text( )” of rule number ‘1’ described in the filter data in FIG. 4 means “all data elements below the route element”. In rule number ‘1’, index type added to the subtree matching the path expression is “lex”. Therefore, the subtree processor 122 acquires the subtree in which “lex” is added to all the data elements below the route element as shown in FIG. 6. Because the descriptor of the rule is “PASS” and a subtree in the intermediate has not been held yet, this subtree becomes the subtree in the intermediate result. The path information is added to the respective elements included in the subtree matching the path expression (for example, as shown by reference numeral 601). Although being omitted for simplification in FIG. 6, it is assumed that the path expression is added in, the same manner to the respective elements other than the data element 602. Further, in the subsequent drawings, it is also assumed that the path information is added to the respective elements included in the subtree matching the path expression.

The respective rules in the filter data shown in FIG. 5 is sequentially applied to the tree structure of the structured-text data shown in FIG. 3. The subtree processor 122 applies the rule of rule number ‘2’ to the tree structure of the structured-text data shown in FIG. 3. Because the path expression is “/bib/book/abstract/Text( )”, the data element immediately below element “abstract”, which is immediately below element “book”, which is immediately below element “bib”, becomes the subtree. A subtree from which the data element of index type “lex” is deleted from the subtree in the intermediate result shown in FIG. 6 becomes the subtree as the intermediate result, based on descriptor “REJECT” and index type “lex” in the rule of rule number ‘2’.

Likewise, the rule of rule number ‘3’ is applied to the tree structure of the structured-text data shown in FIG. 3. Because the path expression is “//numbers//text( )”, the descriptor is “REJECT”, and index type is “lex”. Therefore, the subtree processor 122 deletes all the data elements with index type “lex” below element “numbers”, from the subtree in the intermediate result after the rule of rule number ‘2’ has been applied.

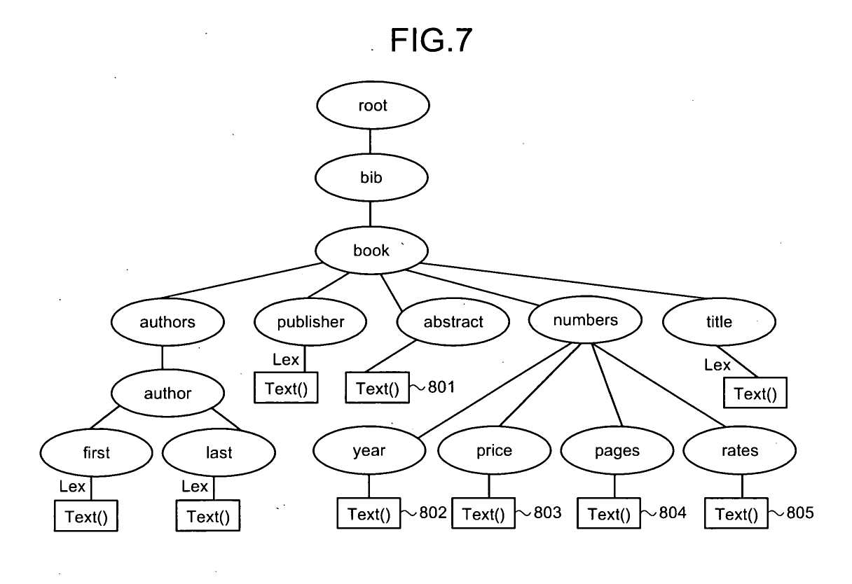

In the subtree in the intermediate result shown in FIG. 7, assignment by index type “lex” is cancelled for the data element 801 at the time of applying the rule of rule number ‘2’ and assignment by index type “lex” is cancelled for data elements 802 to 805 at the time of applying the rule of rule number ‘3’.

The rule of rule number ‘4’ is then applied to the tree structure of the structured-text data shown in FIG. 3. Because the path expression is “//numbers//text( )”, descriptor is “PASS”, and index type is “num”, the subtree processor 122 connects the subtree in the intermediate result after having applied the rule of rule number ‘3’ to the subtree in which index type “num” is assigned to all the data elements below “numbers”.

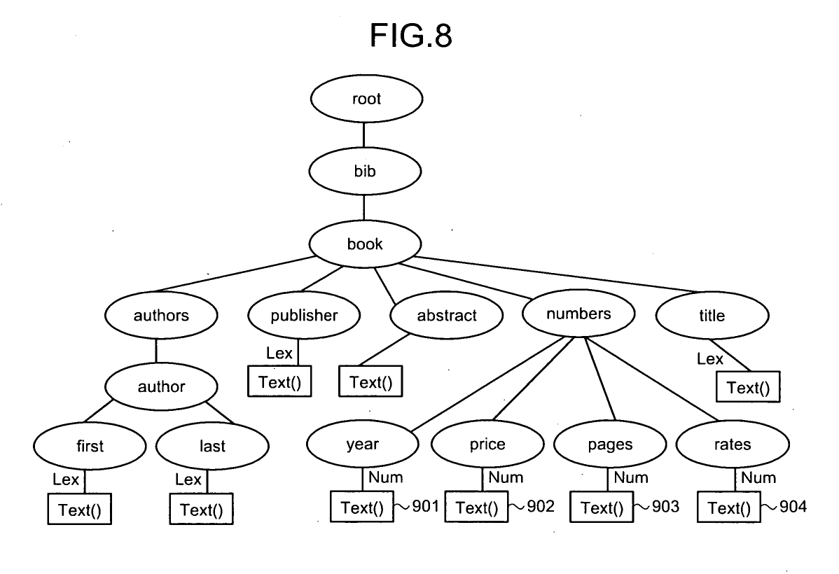

In the subtree in the intermediate result shown in FIG. 8, data elements 901 to 904 are assigned with index type “num” at the time of applying the rule of rule number ‘4’.

The rule of rule number ‘5’ is then applied to the tree structure of the structured-text data shown in FIG. 3. Because the path expression is “//rates//text( )”, descriptor is “REJECT”, and index type is “num”, the subtree processor 122 deletes the data element with index type “num” immediately below element “rates”, relative to the subtree in the intermediate result after having applied the rule of rule number ‘4’. Accordingly, application of all the rules in the filter data finishes.

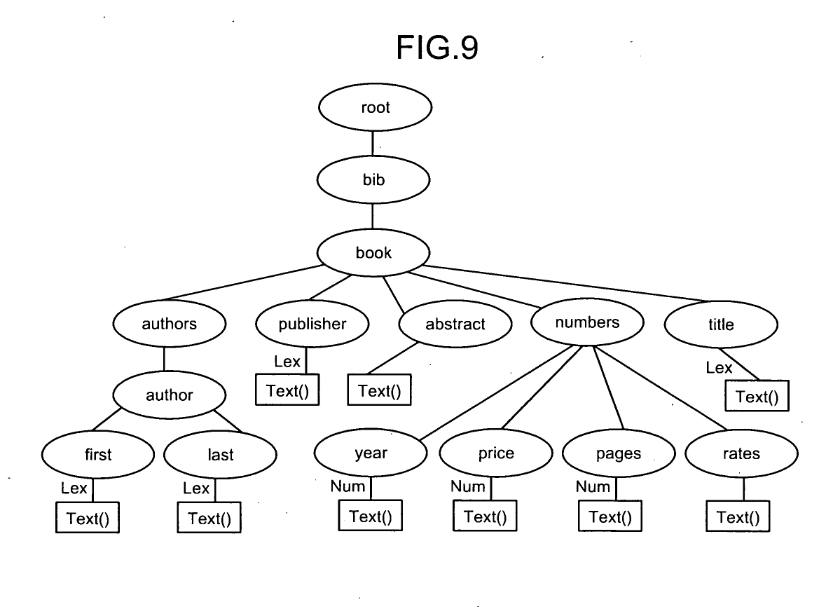

In the subtree after having applied the rules shown in FIG. 9, it can be confirmed that the condition of “setting the lexical index to all elements excluding “abstract” tag and therebelow and “numbers” tag and therebelow, and setting the numerical index to all elements below “numbers” tag excluding “rates” tag, which is intended by the user at the time of describing the filter data, is satisfied. “lex” described above the data element indicates that the index of the data element is generated by lexical. “num” indicates that the index of the data element is generated by a numerical value.

After the process performed by the filter processor 103 has finished, the information of the finally generated subtree and the entity data is output to the search index generator 104. In a case that the finally generated subtree is the subtree shown in FIG. 9, the lexical index generator 141 adds the lexical index to the data elements immediately below element “first”, element “last”, element “publisher”, and element “title”, and stores these in the lexical-index storage unit 131. The numerical-value index generator 142 adds the numerical index to the data elements immediately below element “year”, element “price”, and element “pages”, and stores these in the numerical-index storage unit 132.

Thus, in the structured-text management apparatus 100 according to the first embodiment, the rules described in the filter data are applied to the tree structure in the structured-text data, to increase or decrease assignment of elements included in the subtree in the intermediate result, using the acquired subtree and descriptor.

On the other hand, conventionally, the descriptor and the sequence cannot be set. Therefore, to assign an element by the conventional method, the rule is described only by the path expression (for example, XPath expression).

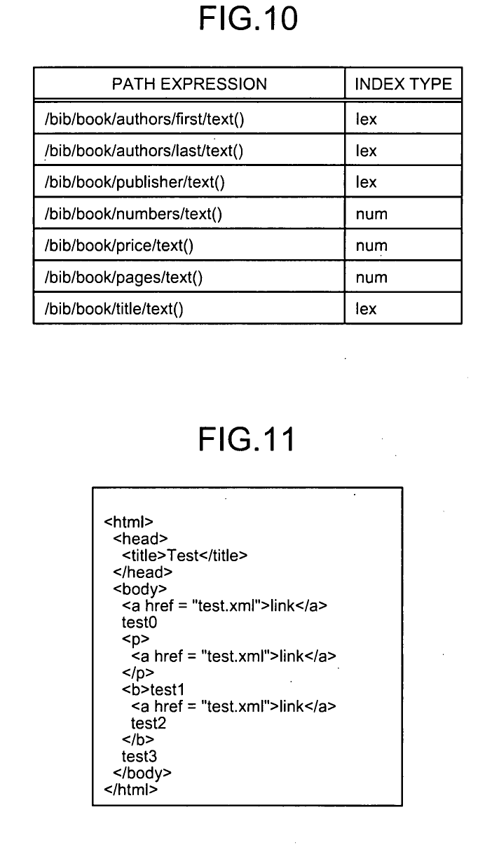

In the filter data shown in FIG. 10, it can be recognized that a path-expression description amount is increased by two lines as compared to the filter data shown in FIG. 4. Further, it can be considered that there is a difference in the path-expression description amount, when an element is extracted from the structured-text data having a more complicated structure. Thus, in the first embodiment, the burden of path description amount on the user can be reduced.

In the conventional filter data, when a complicated condition is defined as the path expression, there is a problem that even if the user refers to the filter data, the user can hardly understand the content of the filter data. On the other hand, in the first embodiment, the element is assigned by a combination of the conventional path expression and assignment/deassignment of elements by the descriptor. Accordingly, the description amount of the filtering condition decreases, and the content of the filter data can be easily understood at the time of referring to the filter data. Further, because the sequence of the rule in which the path expression and the descriptor are combined is defined, description of the condition for assigning the element is further facilitated.

In the first embodiment, a case that the index type is set relative to two types of lexical index and numerical index as the database of the structured-text included in the structured-text management apparatus 100 has been explained. However, the index type is not limited thereto, and the index can be set for each type of various indexes, for example, link index for holding a link between the texts.

Further, the data element explained in the first embodiment is one of the elements constituting the structured-text data. The first embodiment is not limited to an apparatus that assigns the data element to generate the search index, and assignment can be made relative to a structure element such as tag and the attribute.

Thus, by assigning the element by combining “PASS” and “REJECT” relative to the filter, there is no need to assign each element explicitly, thereby enabling flexible correspondence. Particularly, when the filter in which the rules are defined is applied to the structured-text data having a different structure, such an effect that the burden on the user can be reduced can be expected.

Further, when the user appropriately defines a request at the time of assigning the element as a rule relative to the filter data, because the rule has high flexibility, there is a possibility that an element included in the structured-text data can be appropriately assigned, relative to a plurality of structured-texts having different structures and a structured-text having an unclear structure.

Furthermore, because assignment of the element can be flexibly performed, if the structure of the structured-text is changed, the burden at the time of redefining the schema corresponding to the change can be reduced. Because the element is assigned by combining these, expansion of the rule in the filter can be prevented.

While an example of registering one structured-text data in the XML format has been explained in the first embodiment, in a second embodiment, an example of registering a plurality of structured-text data in the XML format is explained.

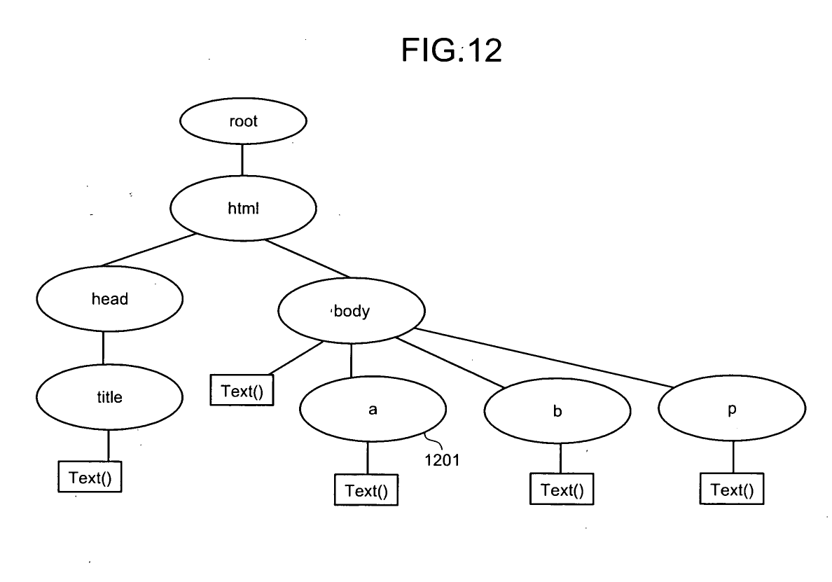

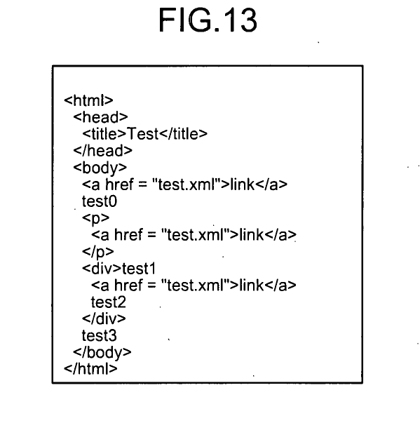

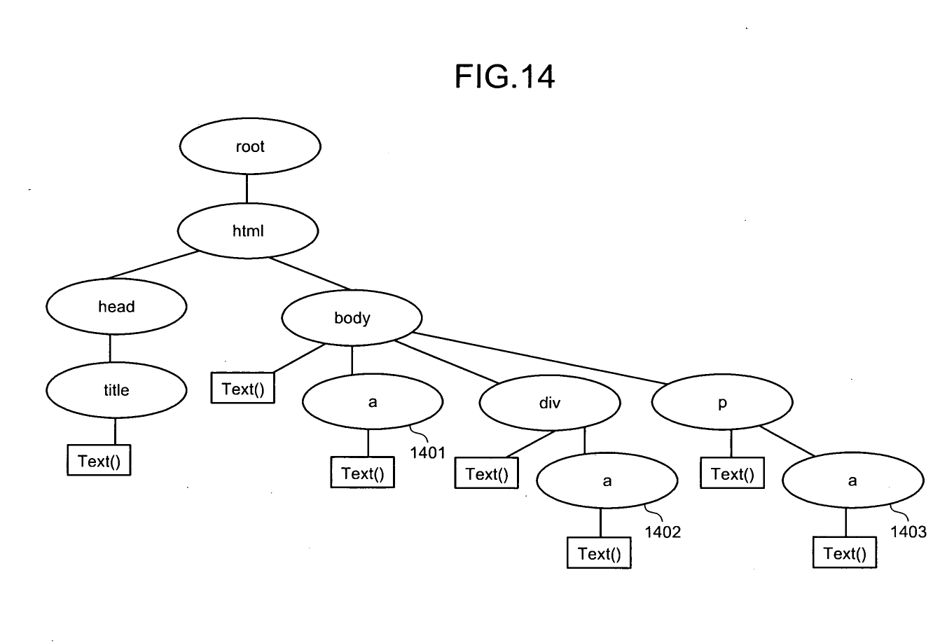

The configuration of the structured-text management apparatus according to the second embodiment is the same as that of the structured-text management apparatus 100 in the first embodiment, and like reference numerals refer to like parts and explanations thereof will be omitted. As a processing object of the structured-text management apparatus 100 according to the second embodiment, first structured-text data shown in FIG. 11 (the tree structure thereof is shown in FIG. 12), and second structured-text data shown in FIG. 13 (the tree structure thereof is shown in FIG. 14) are used.

These first structured-text data and second structured-text data hold the elements indicated by the same name tags. However, frequency of occurrence and structure are different even in the elements having the same name tag between the first structured-text data and the second structured-text data. For example, in the tree structure of the first structured-text data shown in FIG. 12, element “a” 1201 is arranged only immediately below element “body”. On the other hand, in the tree structure of the second structured-text data shown in FIG. 14, elements “a” 1401 to 1403 are arranged not only immediately below element “body” but also immediately below element “p”, which is an element immediately below element “body”, and immediately below element “div”, which is an element immediately below element “body”.

In the conventional method, when an element is assigned to generate an index, relative to the structured-text having a different structure, huge number of path expression description can be required to assign an element. Further, if all elements are assigned by an absolute path at the time of generating the index, the path expression needs to be described, taking into consideration all patterns of the element arrangement, thereby increasing the burden on the user. In the second embodiment, however, if there is regularity in the arrangement of elements for which an index is to be generated, all the patterns need not be described by describing the rule in the filter data according to the regulation. Further, if the regularity can be expressed by a relative path, the burden on the user for describing the path expression can be reduced, by expressing the regularity by the relative path.

For example, there is a case that an element that is not used as a search condition at the time of a search can be included in the elements included in the structured-text data. For example, an element indicated by a decorative tag (which is frequently used in HTML) corresponds thereto. An example of the decorative tag is “br” tag. The “br” tag is the decorative tag for expressing line feed, and does not hold a child element as a subordinate. “p” tag is also the decorative tag for expressing the line feed. The elements indicated by these decorative tags may not be required to be held not only as the index but also as the structure. When the element is assigned by the absolute path, taking the element indicated by the decorative tag into consideration, various modes need to be considered. On the other hand, when the element is assigned by the relative path, a desired element can be assigned in many cases, without taking into consideration the element with the decorative tag in the path expression.

As another example, generally in the structured-text data in the HTML format, in many cases, the entity data of the element indicated by “title” tag stores the heading and the title of the text. The element indicated by “a” tag often holds the link information. The elements indicated by these tags are often used as a condition at the time of a search. Therefore, there are many demands to generate the index for these tags. However, “a” tag and the like have large flexibility in the hierarchy described in the structured-text data. Therefore, when all the hierarchies are taken into consideration, various path expressions need to be described according to the conventional method. However, by describing the path expression according to the relative path and combining the descriptors “PASS” and “REJECT”, these elements can be easily assigned. In the first and the second embodiments, the relative path is set by using the descendant element “//”.

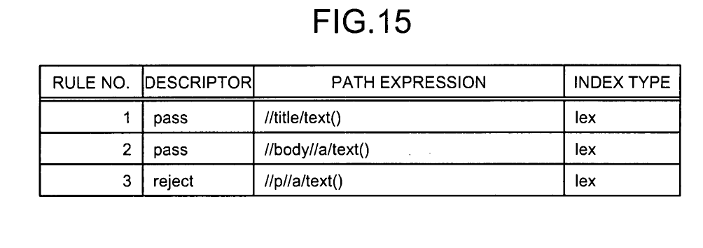

The filter data stored in the filter storage unit 115 shown in FIG. 15 has the same configuration as that of the filter data shown in FIG. 4. The filter data is a filter defined for “generating an index relative to the data element immediately below “title” tag and all data elements immediately below “a” tag, which is below “body” tag but not below “p” tag held by the text”, with respect to the structured-text data”.

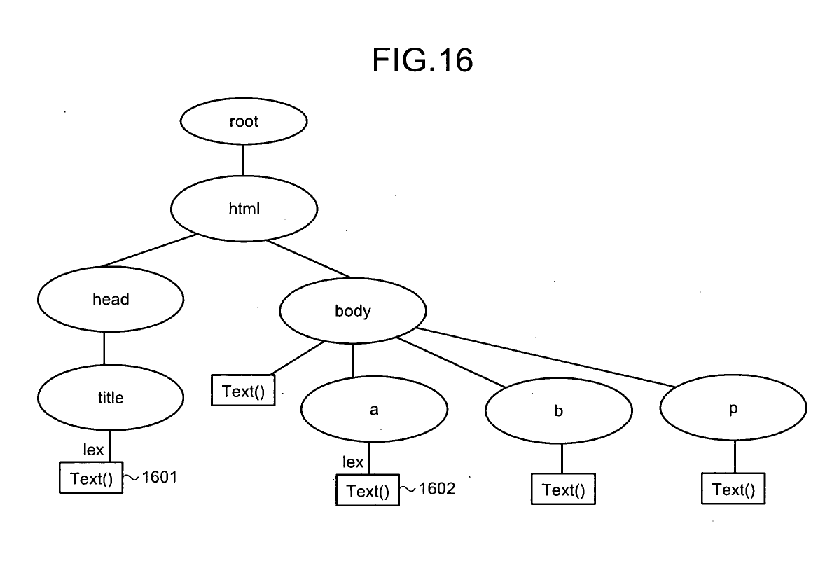

When all the rules in the filter data shown in FIG. 15 are applied to the tree structure of the first structured-text data, as shown in FIG. 16, it can be confirmed that index type “lex” is added to the data elements 1601 and 1602 in the tree structure of the first structured-text data.

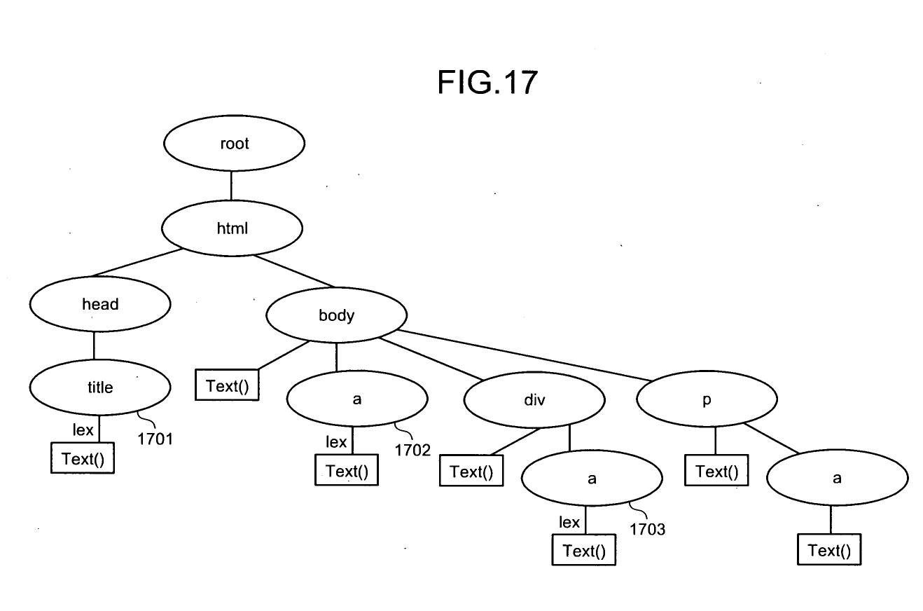

When all the rules in the filter data shown in FIG. 15 are applied to the tree structure of the second structured-text data, as shown in FIG. 17, it can be confirmed that index type “lex” is added to the data elements 1701 to 1703 in the tree structure of the second structured-text data.

Thus, it can be confirmed that the subtrees shown in FIGS. 16 and 17 after the rules have been applied satisfy the object of the filter data, that is, “generating an index relative to the data element immediately below “title” tag and all data elements immediately below “a” tag, which is below “body” tag but not below “p” tag held by the text”.

For example, when “all elements excluding A” are to be assigned at the time of assigning elements, conventionally, it is necessary to describe all the conditions other than ‘A’ it the path expression. According to the second embodiment, however, these conditions can be set as rules, and therefore the description burden on the user can be reduced, and the intention of a describer of the filter data can be easily understood only by referring to the filter data.

In the conventional filter data, the elements included in the structured-text data are assigned only by the path expression. Therefore, when there is a difference in the structure for each of structured-text data, it has been necessary to enumerate all patterns of path expression for each of the structured-text data. However, as explained in the second embodiment, it is not necessary to define a different path expression for each of the structured-text data having different structures, thereby enabling reduction of the burden on the user.

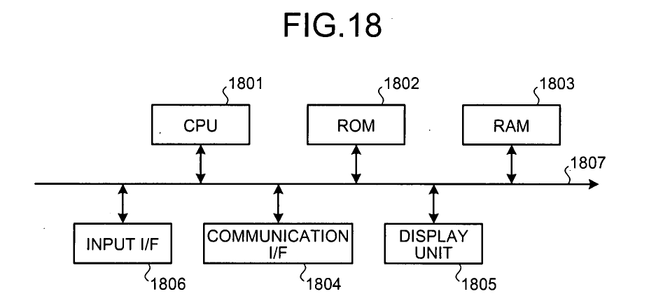

As shown in FIG. 18, the structured-text management apparatus 100 includes, as a hardware configuration, a read only memory (ROM) 1802 that stores a structured-text element assigning program and the like in the structured-text management apparatus 100, a central processing unit (CPU) 1801 that controls respective units in the structured-text management apparatus 100 according to the program in the ROM 1802, a random access memory (RAM) 1803 that stores various data required for the control of the structured-text management apparatus 100, a communication I/F 1804 that connects to a network to perform communication, a display unit 1805 that displays a result of process performed by the structured-text management apparatus 100, an input I/F 1806 for the user to input a processing request or the like, and a bus 1807 for connecting respective units. The structured-text management apparatus 100 can be applied to a general computer having the above-described configuration.

The structured-text element assigning program executed by the structured-text management apparatus 100 according to the above embodiments is recorded on a computer readable recording medium such as a CD-ROM, a floppy disk (FD), a CD-R, or a digital versatile disk (DVD) in an installable or executable format file and provided.

In this case, the structured-text element assigning program is read from the recording medium and executed by the structured-text management apparatus 100, thereby being loaded on a main memory, so that respective units explained in the software configuration are generated on the main memory.

Further, the structured-text element assigning program executed by the structured-text management apparatus 100 according to the embodiments can be stored on the computer connected to the network such as the Internet, and downloaded via the network. Alternatively, the structured-text element assigning program executed by the structured-text management apparatus 100 according to the embodiments can be provided or distributed via the network such as the Internet.

Further, the structured-text element assigning program executed by the structured-text management apparatus 100 according to the embodiments can be incorporated in the ROM or the like and provided.

The structured-text element assigning program executed by the structured-text management apparatus 100 according to the embodiments has a module configuration including respective units, and as actual hardware, the CPU (processor) reads the structured-text element assigning program from the storage medium and executes the program, thereby respective units are loaded onto the main memory and generated on the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for assigning an element in a structured-text comprising:
a storage unit that stores element-assigning correspondence information in which a structure path expression and assignment information are associated with each other, the structure path expression specifying an element relative to a structured-text that holds elements using a hierarchical logical structure, and the assignment information defining assignment/deassignment of the element specified by the structure path expression;
an acquiring unit that acquires an element matching the structure path expression from the structured-text, based on the structure path expression in the element-assigning correspondence information;
an assignment acquiring unit that acquires the assignment information associated with the structure path expression used for acquiring the element from the element-assigning correspondence information;
an element determining unit that determines whether to assign or deassign the element based on the acquired assignment information; and
an assigning unit that assigns or deassigns the element determined by the element determining unit.

2. The apparatus according to claim 1, wherein
a sequencing is performed for each structure path expression in the element-assigning correspondence information in the storage unit, and
processes by the acquiring unit, the assignment acquiring unit, the element determining unit and the assigning unit are repeated according to the sequence, using the structure path expression in the sequence.

3. The apparatus according to claim 1, wherein the assigning unit adds identification information for identifying the element relative to the assigned element.

4. The apparatus according to claim 3, wherein the assigning unit adds path information for indicating a position of the element in the structured-text to the assigned element as the identification information.

5. The apparatus according to claim 3, further comprising a search index generator that generates a search index that associates entity information stored in the element added to the identification information with the identification information.

6. The apparatus according to claim 5, further comprising a search processor that searches for an element stored in the structured-text using the generated search index.

7. The apparatus according to claim 1, wherein
the storage unit further stores index type information for setting a type to the entity information of the element in the element-assigning correspondence information in association with other pieces of information, and
the assigning unit further assigns the index type information associated with the structure path expression used for specifying the element, relative to the element determined to be assigned.

8. The apparatus according to claim 7, further comprising a confirming unit that confirms whether the set index type information is appropriate relative to the entity information of the element.

9. The apparatus according to claim 7, further comprising a search index generator that generates a search index for searching the entity information stored in the element for each index type information set for each element.

10. The apparatus according to claim 1, further comprising a receiving unit that receives an input of the element-assigning correspondence information, wherein
the receiving unit outputs the input element-assigning correspondence information to the storage unit.

11. The apparatus according to claim 1, wherein
the acquiring unit acquires structured information including one or a plurality of elements matching the structure path expression from the structured-text, based on the structure path expression in the element-assigning correspondence information,
the element determining unit determines whether to assign or deassign the structured information from the acquired assignment information, and
the assigning unit connects or deletes the determined structured information relative to intermediate structured information acquired as a result of assignment or deassignment, and treats each element included in the structured information acquired as a result of connection or deletion, as being assigned.

12. The apparatus according to claim 1, wherein the structure path expression can be described in a relative path in the element-assigning correspondence information in the storage unit.

13. The apparatus according to claim 1, further comprising:
a structured-text storage unit that stores structured-text data which is an object of element-assignment; and
a storage processor that performs a process for storing the structured-text data including the assigned element in the structured-text storage unit.

14. A method for assigning an element of a structured-text comprising:
acquiring element-assigning correspondence information it which a structure path expression and assignment information are associated with each other, the structure path expression specifying an element relative to a structured-text that holds elements using a hierarchical logical structure, and the assignment information defining assignment/deassignment of the element specified by the structure path expression;
acquiring an element matching the structure path expression from the structured-text, based on the structure path expression in the acquired element-assigning correspondence information;
acquiring the assignment information associated with the structure path expression used for acquiring the element from the element-assigning correspondence information;
determining whether to assign or deassign the element based on the acquired assignment information; and
performing assigning or deassigning the element determined by the element determining unit.

15. A computer program product having a computer readable medium including programmed instructions for assigning an element in a structured-text, wherein the instructions, when executed by a computer, cause the computer to perform:
acquiring element-assigning correspondence information in which a structure path expression and assignment information are associated with each other, the structure path expression specifying an element relative to a structured-text that holds elements using a hierarchical logical structure, and the assignment information defining assignment/deassignment of the element specified by the structure path expression;
acquiring an element matching the structure path expression from the structured-text, based on the structure path expression in the acquired element-assigning correspondence information;
acquiring the assignment information associated with the structure path expression used for acquiring the element from the element-assigning correspondence information;
determining whether to assign or deassign the element based on the acquired assignment information; and
performing assigning or deassigning the element determined by the element determining unit.
